(19) United States
(12) Patent Application Publication
(10) Pub. No.: US 2013/0110708 A1
(43) Pub. Date: May 2, 2013

(54) APPARATUS AND METHOD OF COMPLETING PAYMENT DURING A TRANSACTION

(71) Applicant: Morrison Reyner, Duluth, GA (US)

(72) Inventor: Morrison Reyner, Duluth, GA (US)

(73) Assignee: NCR CORPORATION, Duluth, GA (US)

(21) Appl. No.: 13/301,504

(22) Filed: Nov. 21, 2011

Related U.S. Application Data
(60) Provisional application No. 61/553,783, filed on Oct. 31, 2011.

(51) Int. Cl. G06Q 20/18

(52) U.S. Cl. 705/39

(57) ABSTRACT

An apparatus and method of completing payment during a transaction which improves usability during a transaction by employing a picture-in-picture adapter to display payment screens with transaction screens on a primary display. An example method includes receiving a request to process payment from a transaction terminal by a payment peripheral, identifying a message to display within a payment screen by the payment peripheral, sending a signal to a video picture-in-picture adapter to display the payment screen containing the message, displaying the payment screen within a transaction screen from the transaction terminal by the video picture-in-picture adapter based upon display settings stored within the video picture-in-picture adapter, receiving information from the customer by the payment peripheral, and sending the information to the transaction terminal to complete the transaction by the payment peripheral.

### CROSS-REFERENCE TO RELATED APPLICATIONS

This application claims the benefit of U.S. Provisional Application No. 61/553,783, filed Oct. 31, 2011.

### BACKGROUND

The present invention relates to transaction systems with electronic payment devices, and more specifically to an apparatus and method of completing payment during a transaction.

Transaction terminals generally include a payment device, which is generally a stand alone device with a numerical keypad, a screen display, and a card reader. The display displays lead through information. For example, the payment device may display messages such as “enter PIN,” “Please Sign”, and an echo of “****”.

Payment devices are typically certified to be compliant with Payment Card Industry (PCI) and Europay, MasterCard and VISA (EMV) standards.

A disadvantage associated with such payment devices is poor operator experience. The operator's focus has to switch from a primary display where all the transaction screens are displayed to the display of the payment device, which is smaller and typically a monochrome liquid crystal display (LCD), and back to the primary display.

Attempts to replicate or integrate payment processing into a transaction application running on the transaction terminal require PCI and EMV certification of the transaction application which can be a time consuming and expensive activity.

Therefore, it would be desirable to provide an alternative to integration of payment processing into the transaction application to enhance operator experience.

### SUMMARY

In accordance with the teachings of the present invention, an apparatus and method of completing payment during a transaction is provided.

An example method includes receiving a request to process payment from a transaction terminal by a payment peripheral, identifying a message to display within a payment screen by the payment peripheral, sending a signal to a video picture-in-picture adapter to display the payment screen containing the message, displaying the payment screen within a transaction screen from the transaction terminal by the video picture-in-picture adapter based upon display settings stored within the video picture-in-picture adapter, receiving information from the customer by the payment peripheral, and sending the information to the transaction terminal to complete the transaction by the payment peripheral.

An example system includes a transaction terminal for generating a first video signal containing a transaction screen, a payment terminal for generating a second video signal containing a payment screen containing a message in response to a request for payment information from the transaction terminal, a display, and video picture-in-picture adapter for causing the display to display the payment screen from the payment device within the transaction screen from the transaction terminal based upon display settings stored within the video picture-in-picture adapter in response to receiving the first and second video signals.

The video picture-in-picture adapter can be configured to take a range of video inputs from both the payment peripheral and the transaction terminal.

It the absence of any signal from the payment device the video picture-in-picture adaptor passes through the entire signal from the transaction terminal.

When a signal is present from the payment device the video picture-in-picture adaptor combines the video signal from the payment device with the video signal from the transaction terminal. The size, position, border, color palette and other attributes of the screen image from the payment device can be pre-set on the picture-in-picture adaptor and/or be configured from the transaction terminal and/or a remote computer via a network connection to the video picture-in-picture adaptor.

Since settings are maintained locally, the video picture-in-picture adaptor operates independently of other devices. The transaction terminal, the payment terminal, and the display continue to operate as they would absent video PIP circuitry.

### BRIEF DESCRIPTION OF THE DRAWINGS

FIG. 1 is a block diagram of a transaction system;

FIG. 2 is an example transaction screen;

FIG. 3 is a flow diagram illustrating an example payment method.

### DETAILED DESCRIPTION

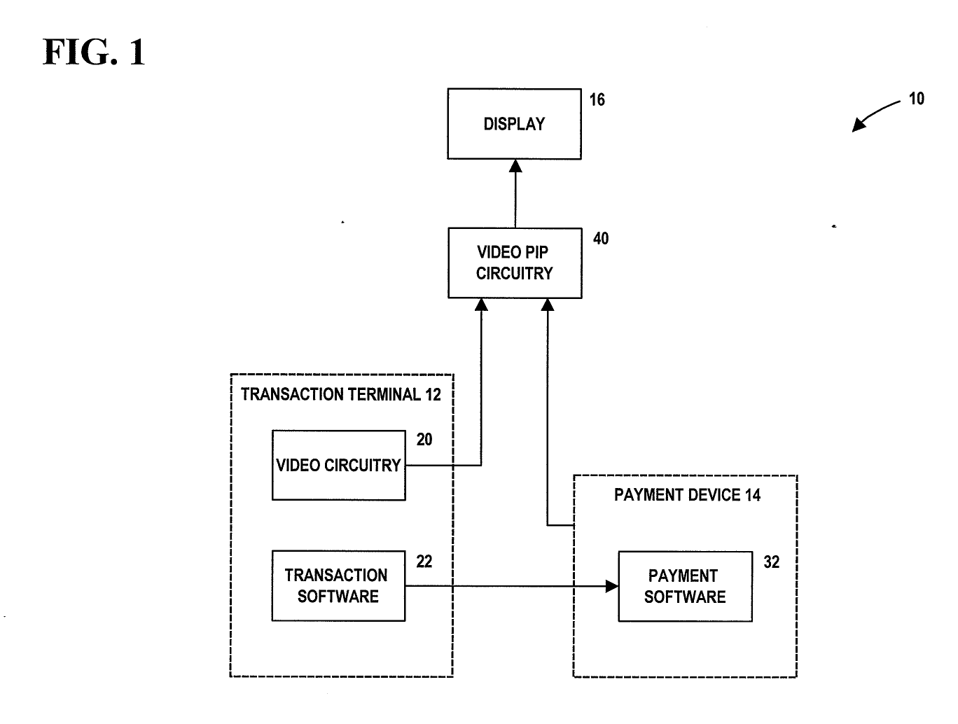

Turning now to FIG. 1, transaction system 10 primarily includes transaction terminal 12, payment device 14, and display 16.

Transaction terminal 12 executes transaction software 22 for displaying transaction screens and processing operator entries and selections during a transaction, such as a transaction involving the sale of goods or services.

Transaction software 22 may also display prompts to an operator that payment information is required from payment device 14. Transaction software 22 waits for payment information to be sent from payment device 14. After a customer provides payment information, for example, by swiping a payment card through a card reader slot in payment device 14, transaction software 22 uses the payment information to complete the transaction.

Transaction terminal 12 may include an assisted service transaction terminal or a self-service transaction terminal, such as a kiosk.

Transaction terminal 12 includes a processor, memory, and program and data storage. Transaction terminal 12 may execute an operating system such as a Microsoft operating system. Transaction terminal 12 may execute other computer software besides transaction software 22 that may be stored in a computer readable medium, such as a memory.

Transaction terminal 12 further includes video circuitry 20 for connecting to display 16 to facilitate display of transaction screens from transaction software 22. An example video circuitry 20 may include a video graphics array (VGA) standard video circuitry and display 16 may be a VGA compatible display. Other graphics standards are also envisioned.

Transaction terminal 12 may further include other circuitry, such as network circuitry for connecting to a network of transaction terminals 12, and other circuitry for connecting to any one or more of additional peripherals, such as a printer, an input device or a touch overlay of display 16, a barcode reader, radio frequency device reader, or other peripheral necessary for the purpose of transaction terminal 12.

Payment device 14 executes payment software 32 for displaying payment related messages, processing operator entries and selections, and receiving payment information from a payment card during a payment portion of a transaction. For example, payment software 32 processes operator entry of a personal identification number (PIN) or operator selection of a payment card type. Payment software 32 also sends payment information to transaction software 22.

Payment device 14 includes a processor, memory, and program and data storage. Payment device 14 may execute an operating system. Payment device 14 may execute other computer software that may be stored in a computer readable medium, such as a memory.

Payment device 14 may further include peripherals and associated circuitry, such as a card reader, a keypad, and a display.

System 10 further includes video picture-in-picture (PIP) adapter or circuitry 40. Video PIP circuitry 40 acts as video circuitry for payment device 14 for displaying payment related screens or messages from payment software 32 on display 16. Video PIP circuitry 40 further facilitates simultaneous display of transaction screens from transaction software 22 with payment related screens or messages. For that purpose, video PIP circuitry 40 also connects to video circuitry 20 to receive transaction screens from transaction software 22.

It the absence of any signal from payment device 14, video PIP circuitry 40 passes through the entire signal from transaction terminal 12 to display 16.

When payment software 32 initiates display of payment messages, for example, when payment software 32 requires customer input, such as PIN entry, video PIP circuitry 40 receives a signal from payment device 14. Video PIP circuitry 40 combines the video signal from payment device 14 with the video signal from transaction terminal 12. The video signal from video circuitry 20 “loops” or passes through video PIP circuitry 40 to display 16. Thus, video PIP circuitry 40 places the video screen from payment device 14 in a predetermined portion of a transaction screen from transaction software 22.

Video PIP circuitry 40 can be configured to take a range of video inputs from both payment device 14 and the transaction terminal 12. The size and location of the portion of the display area of display 16 occupied by the PIP screen from payment device 14 may also be configurable up to the entire display area of display 16. Other attributes, such as border and color palette may also be configured. Configuration may occur from transaction terminal 12 or a remote computer via a network connection to video PIP circuitry 40. Default attributes may initially be pre-set within video PIP circuitry 40.

Since settings are maintained locally, video PIP circuitry 40 operates independently of other devices. For example, transaction terminal 12, payment device 14, and display 16 are unaware of video PIP circuitry 40 and continue to operate as they would absent video PIP circuitry 40.

Video PIP circuitry 40 may be internal or external to payment device 14. Video PIP circuitry 40 may be used in conjunction with internal video circuitry within payment device 14, if present. Alternatively, internal video circuitry present within payment device 14 may be disabled or removed. As yet another alternative, payment device 14 may be a lower cost payment device without its own internal video circuitry and display, coupling to external video circuitry, such as video PIP circuitry 40. Payment device 14 may include a video out port for facilitating a cable connection between payment device 14 and video PIP circuitry 40.

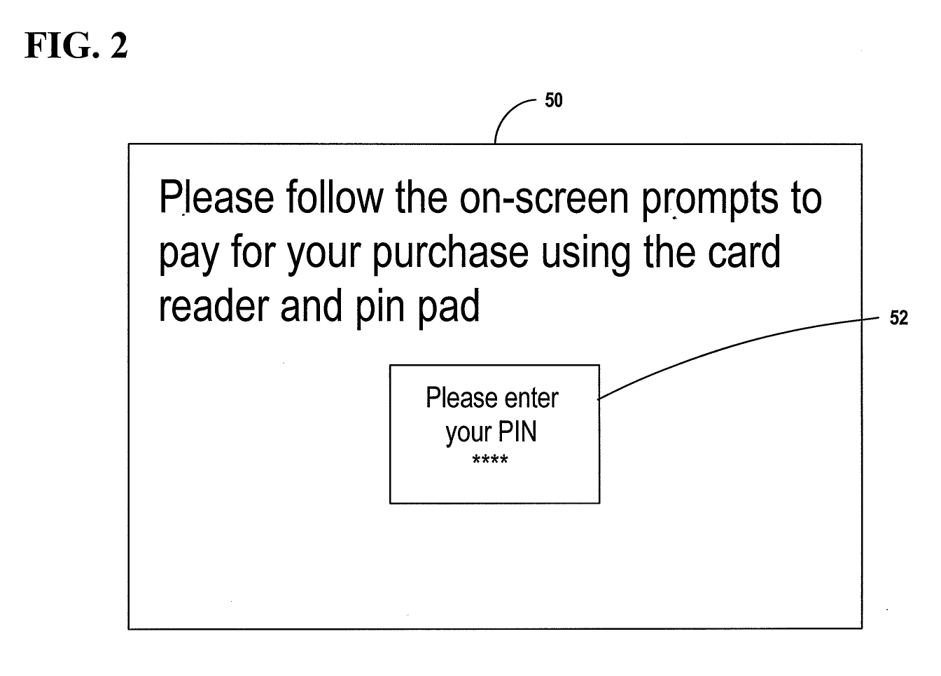

With reference to FIG. 2, example screens 50 and 52 from transaction software 22 and payment software 32 as displayed by display 16 are illustrated, with screen 52 from payment software 32 being the PIP screen within transaction screen 50 from transaction software 22.

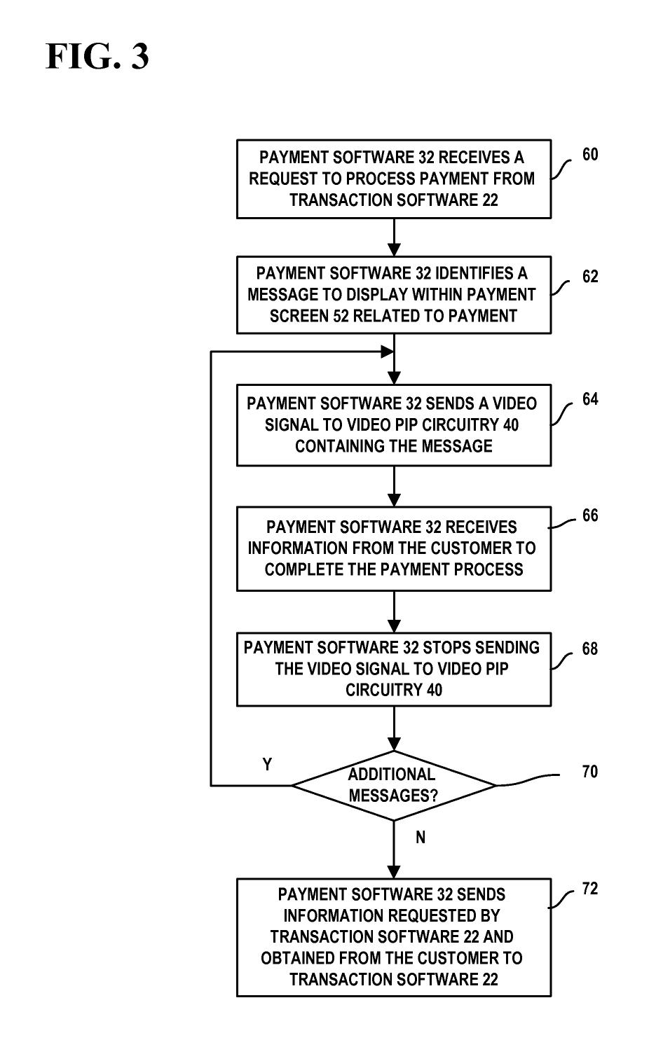

Turning now to FIG. 3, an example method is illustrated beginning with step 60.

In step 60, payment software 32 receives a request to process payment from transaction software 22, including a request for certain payment information that transaction software 22 requires to complete a transaction.

In step 62, payment software 32 identifies a message to display within payment screen 52 related to payment.

In step 64, payment software 32 sends a video signal to video PIP circuitry 40 containing the message.

Video picture-in-picture circuitry 40 displays screen 52 containing the message based upon locally stored settings, including dimensions and location while displaying transaction screen 50 from transaction software 22.

In step 66, payment software 32 receives information from the customer to complete the payment process. For example, if the message is requests that the customer swipe a credit or debit card, payment software 32 receives the card information from a card reader within payment device 14. As another example, if the message requests that the customer enter a PIN, payment software 32 receives the PIN from a keypad within payment device 14.

In step 68, payment software 32 stops sending the video signal to video PIP circuitry 40.

In step 70, payment software 32 determines whether it must display additional messages and screens 52 to finish the payment process. If so, operation returns to step 64. Otherwise, operation proceeds to step 72.

In step 72, payment software 32 sends information requested by transaction software 22, and obtained from the customer, to transaction software 22 so that transaction software 22 can complete the transaction.

Although the present invention has been described with particular reference to certain preferred embodiments thereof, variations and modifications of the present invention can be effected within the spirit and scope of the following claims.

1. A payment method process comprising:
receiving a request to process payment from a transaction terminal by a payment peripheral;
identifying a message to display within a payment screen by the payment peripheral;
sending a signal to a video picture-in-picture adapter to display the payment screen containing the message;
displaying the payment screen within a transaction screen from the transaction terminal by the video picture-in-picture adapter based upon display settings stored within the video picture-in-picture adapter;
receiving information from a customer by the payment peripheral; and
sending the information to the transaction terminal to complete the transaction by the payment peripheral.

2. A transaction system comprising:
a transaction terminal for generating a first video signal containing a transaction screen;
a payment terminal for generating a second video signal containing a payment screen containing a message in response to a request for payment information from the transaction terminal;
a display; and
a video picture-in-picture adapter for causing the display to display the payment screen from the payment terminal within the transaction screen from the transaction terminal based upon display settings stored within the video picture-in-picture adapter in response to receiving the first and second video signals.
